(19) United States
(12) Patent Application Publication
(10) Pub. No.: US 2014/0040112 A1
(43) Pub. Date: Feb. 6, 2014

(54) Pre-Validation of Orders

(71) Applicant: OMX TECHNOLOGY AB, Stockholm (SE)

(72) Inventors: Johan Bergenudd, Danderyd (SE); Gustav Montgomerie-Neilson, Stockholm (SE)

(73) Assignee: OMX TECHNOLOGY AB, Stockholm (SE)

(21) Appl. No.: 13/957,883

(22) Filed: Aug. 2, 2013

Related U.S. Application Data
(60) Provisional application No. 61/680,029, filed on Aug. 6, 2012.

(51) Int. Cl. G06Q 40/04

(52) U.S. Cl. CPC G06Q 40/04
USPC 705/38

(57) ABSTRACT

Technology is presented that more efficiently calculates a worst case margin requirement for a particular order. The calculated worst case margin requirement is compared to pledged collateral for a particular order to determine if the margin is above the pledged collateral amount. If the calculated worst case margin requirement exceeds the pledged collateral, then the order is not processed (i.e., matched). In determining the worst case margin requirement, several factors may be taken into account including, but not limited to, a scanning risk, an intermonth spread charge, and/or a delivery month spread charge.

### CROSS-REFERENCES TO RELATED APPLICATIONS

This application claims the benefit of priority from provisional application No. 61/680,029 filed Aug. 6, 2012, the contents of which are incorporated herein by reference.

### BACKGROUND OF THE TECHNOLOGY

Electronic exchanges provide users with a fast and efficient way for trading financial instruments. Electronic exchange systems have evolved greatly over the years and take into account a variety of factors when processing orders. For example, the electronic exchanges are when matching an order capable of validating orders to determine if an order is too high a risk to match, where risk relates to the ability of an entity responsible for the order to fulfill the responsibilities that result from the match of that order. One way to protect against risk is to require a trading entity to maintain a margin in a trading account.

Margin calculations related to the required collateral needed, e.g., for a derivative portfolio, may be made primarily on a portfolio basis. Such calculations take into account orders in a portfolio that have been completed (i.e., matched and processed).

There is a general desire to evaluate risk of incoming orders and have the ability to automatically reject orders that will increase the margin requirements above a certain threshold (e.g., the currently pledged collateral value). For example, if a worst case margin requirement is higher than a threshold value for a particular order for an account, then the order should be rejected; otherwise, it should be accepted.

The Standard Portfolio Analysis of Risk (SPAM)) system presently calculates margin requirements for portfolios for a given account. SPAN® was originally developed by the Chicago Mercantile Exchange in 1988 and is nowadays a widely used system to calculate margin requirements. The SPAN® methodology comprises a series of calculations, including portfolio stress testing and commodity price correlations that can yield the worst possible performance loss a certain portfolio can suffer over a given time period. To do this, SPAN® generally leverages a set of parameters set by a clearinghouse, or clearinghouse system, reflecting the market conditions of traded financial instruments and allowing the clearinghouse to choose its desired degree of coverage.

SPAN® is generally based on the division of orders of financial instruments in so-called combined commodities, i.e. groupings of orders that share the same underlying asset. For example, a portfolio containing futures contracts and options on futures contracts are segmented into different bins (combined commodities), where each bin only contains contracts of one specific asset, such as steel or copper to name only two examples. SPAN® then performs a number of calculations, some on each combined commodity separately and some on all combined commodities in a portfolio.

SPAN® calculations yield as a final result an initial margin requirement, aka margin requirement. The margin requirement represents the loss of value of the portfolio in a worst-case risk scenario. In the SPAN® (Delta Hedge) margin model, the margin requirement is calculated by adding (or subtracting) a number of margin components. The formula for the margin requirement may, e.g., be:

Initial Margin Requirement=max(Scanning Risk+Intermonth Spread Charge+Delivery Month Charge−Intercommodity Spread Credit, Short Option Minimum Charge)−Net Option Value

Generally, each of the terms in the formula requires a separate calculation and is also performed in different ways on the portfolio. Usually, the dominant component is the scanning risk, as discussed further below, but other margin components are considered as well.

The scanning risk is determined by calculating the theoretical price of each investment position in the portfolio at multiple different scenario points (e.g., 16). A scenario point is represented by an underlying price of the underlying asset and an implied volatility (stressed values compared to the current market price). Within an underlying (or combined commodity), a net calculation is performed where all positions are added in each scenario point, resulting in a profit or loss in that scenario point. A worst case loss at one of these scenario points can represent the scanning risk.

It should be appreciated that the stressed values can refer to the shifting of the underlying asset's price and volatility where the stressed values result in the scenario points where the value of the portfolio is calculated. The term “underlying” can also refer to what an instrument (e.g., a derivative) will/can turn into upon expiration (when using physical delivery as opposed to cash settlement).

Another margin component is related to an intermonth spread charge. The intermonth spread charge is calculated for groups of orders with the same underlying asset (combined commodity). These orders are assigned to preconfigured tiers, where each tier corresponds to orders with maturities in a specified range. Tier spread charges are then assigned to spreads formed within and between all the tiers in the combined commodity. The magnitude of the spread charges and the order in which spreads are formed between tiers are preconfigured. The sum total of all spread charges in all combined commodities in the portfolio is the intermonth spread charge.

Yet another margin component is related to a delivery month charge. The delivery month charge relates to orders with maturity less than one month, and assigns risk based on the position deltas of these orders. Spreads are formed according to a priority list using the position deltas of the orders in the delivery month and higher maturities. Normally, the delivery month has the highest priority. The spreads are assigned a delivery month spread charge, and for position deltas in the delivery month that cannot be used to form spreads, the remaining positions are assigned an outright charge (which is usually larger). The delivery month charge is the sum of the delivery month spread charges and the outright charges.

A drawback to systems using the SPAN® model is that they only calculate margin requirements for transactions which have already been executed i.e. for portfolios. That is, systems using the SPAN® model does not consider orders awaiting matching (i.e., non-matched, open orders) when determining a margin requirement for a particular account. As each order may or may not become executed i.e. matched and processed, it is difficult to evaluate whether an open order will increase or decrease the margin requirement for the account.

One solution could be to calculate margin requirement for all possible portfolios that can result from the open orders in the orderbook for that account. However, this is problematic because it requires an exponentially high number of possible portfolios (i.e., 2̂(# of orders)). Such an exponential amount requires an unreasonably large number of time consuming calculations in order to perform pre-order validation in real-time, or in substantially real-time. Thus, it would be advantageous to have a system that provides more efficient pre-order validation calculations so that margin components can be calculated relatively accurately and in real-time, or in substantially real-time.

### BRIEF SUMMARY OF THE TECHNOLOGY

Technology is presented that more efficiently calculates a worst case margin requirement for a particular order. The calculated worst case margin requirement is compared to pledged collateral for a particular order to determine if the margin is above the pledged collateral amount. If the calculated worst case margin requirement exceeds the pledged collateral, then the order is not processed (i.e., matched). In determining the worst case margin requirement, several factors may be taken into account including, but not limited to, a scanning risk, an intermonth spread charge, and/or a delivery month spread charge.

A method is presented for pre-validating orders submitted to an exchange system, prior to the orders being accepted by the exchange system for matching, and implemented in a pre-order validation apparatus having at least one processor. The method comprises receiving an electronic data message including an order for pre-order validation, the order comprising information associated with an account, performing a risk analysis for portfolios associated with the account to determine if, based on the risk analysis, the received order will be cleared so that the exchange can attempt to match the received order, performing the risk analysis for unmatched orders, previously accepted for matching at the exchange, associated with the account and the received order to determine if the received order will be cleared so that the exchange can attempt to match the received order, calculating, by the at least one processor, a margin requirement value for the account based on the risk analysis performed for the portfolios and the orders, determining, by the at least one processor, if the margin requirement value for the account is higher than a threshold value for the account, and clearing the order for matching when the margin requirement value for the account is equal to or lower than the threshold value for the account.

A non-transitory computer-readable storage medium having computer readable code embodied therein and capable of being stored in a memory as computer program instructions is presented, which when executed by a computer having one or more processors, performs functionality comprising receiving an electronic data message including an order for pre-order validation, the order comprising information associated with an account, performing a risk analysis for portfolios associated with the account to determine if, based on the risk analysis, the received order will be cleared so that the exchange can attempt to match the received order, performing the risk analysis for unmatched orders, previously accepted for matching at the exchange, associated with the account and the received order to determine if the received order will be cleared so that the exchange can attempt to match the received order, calculating, by the at least one processor, a margin requirement value for the account based on the risk analysis performed for the portfolios and the orders, determining, by the at least one processor, if the margin requirement value for the account is higher than a threshold value for the account, and clearing the order for matching when the margin requirement value for the account is equal to or lower than the threshold value for the account.

A pre-order validation apparatus is presented comprising a memory configured to store one or more orders for pre-order validation processing and at least one processor, coupled to the memory, and configured to execute pre-validation of orders submitted to an exchange system, prior to the orders being accepted by the exchange system for matching The at least one processor configured to perform functionality comprising receiving an electronic data message including an order for pre-order validation, the order comprising information associated with an account, performing a risk analysis for portfolios associated with the account to determine if, based on the risk analysis, the received order will be cleared so that the exchange can attempt to match the received order, performing the risk analysis for unmatched orders, previously accepted for matching at the exchange, associated with the account and the received order to determine if the received order will be cleared so that the exchange can attempt to match the received order, calculating, by the at least one processor, a margin requirement value for the account based on the risk analysis performed for the portfolios and the orders, determining, by the at least one processor, if the margin requirement value for the account is higher than a threshold value for the account, and clearing the order for matching when the margin requirement value for the account is equal to or lower than the threshold value for the account.

A pre-order validation system is presented comprising an order creating device and a pre-order validation apparatus. The order creating device having a memory configured to store one or more orders, at least one processor coupled to the memory and configured to process the one or more stored orders, and a data transceiver device configured to conduct transmission of one or more orders. The pre-order validation apparatus having a memory configured to store one or more orders for pre-order validation processing, a data transceiver device configured to conduct transmission of the one or more orders transmitted from the order creating device, and at least one processor, coupled to the memory and the data transceiver, and configured to execute pre-validation of orders submitted to an exchange system, prior to the orders being accepted by an exchange system for matching. The at least one processor configured to perform functionality comprising receiving an electronic data message including an order for pre-order validation, the order comprising information associated with an account, performing a risk analysis for portfolios associated with the account to determine if, based on the risk analysis, the received order will be cleared so that the exchange can attempt to match the received order, performing the risk analysis for unmatched orders, previously accepted for matching at the exchange, associated with the account and the received order to determine if the received order will be cleared so that the exchange can attempt to match the received order, calculating, by the at least one processor, a margin requirement value for the account based on the risk analysis performed for the portfolios and the orders, determining, by the at least one processor, if the margin requirement value for the account is higher than a threshold value for the account, and clearing the order for matching when the margin requirement value for the account is equal to or lower than the threshold value for the account.

In a non-limiting, example implementation components of the margin requirement value calculations are determined based on at least one of a scanning risk, an intermonth spread charge, or a delivery month charge.

In another non-limiting, example implementation one or more scenario points for the account are established, each scenario point based on an underlying price and a volatility, for each of the one or more scenario points, a profit or a loss value is determined, a worst case scenario point representing a highest loss and setting the profit or loss value in the worst case scenario point is determined as the scanning risk, and the margin requirement value is modified based on the highest loss in the scanning risk.

In yet another non-limiting, example implementation each order that contributes with a loss in each scenario point is identified, and in determining the profit or loss value for each of the one or more scenario points, a profit or loss value is calculated where the calculation is based on a profit or loss value of the portfolios and a loss value associated with the identified orders in each scenario point.

In another non-limiting, example implementation the intermonth spread charge is set to a predetermined value, a tier structure having a plurality of tiers is reduced to a single tier containing all orders, a tier spread charge corresponding to a largest preconfigured tier spread charge is assigned, an upper bound value of the intermonth spread charge is determined based on the tier spread charge and an assumption that all orders in the order book have been matched, and the margin requirement value is modified based on the upper bound value.

In yet another non-limiting, example implementation a delivery month is determined based on a current calendar month, one or more orders in the orderbook for an account that could match for the delivery month are determined, one or more portfolios are calculated based on the one or more orders in the orderbook that could match for the delivery month, a first portfolio having a highest number of long positions is selected, a second portfolio having a highest number of short positions is selected, whether the first portfolio or the second portfolio has a highest number of outright positions is determined, either the first portfolio or the second portfolio is selected when the portfolio is determined to have the highest number of outright positions, an upper bound value of the delivery month charge is determined based on the selected first or second portfolio, and the margin requirement value is modified based on the upper bound value of the delivery month charge.

In another non-limiting, example implementation the margin requirement value may be modified by adding together one or more of the scanning risk, the intermonth spread charge, and the delivery month charge

### BRIEF DESCRIPTION OF THE DRAWINGS

FIG. 1 shows a function block diagram of an example embodiment of an exchange system 300;

FIG. 2 shows an example block diagram of an exchange system 300 performing pre-order validation on an order;

FIG. 3 shows an example application flowchart of a method for calculating a scanning risk during preorder validation;

FIG. 4 shows an example application flowchart of a method for calculating an approximate upper bound on an intermonth spread charge during preorder validation; and

FIG. 5 shows an example application flowchart of a method for calculating an approximate upper bound on a delivery month charge during preorder validation.

### DETAILED DESCRIPTION OF EXAMPLE EMBODIMENTS OF THE TECHNOLOGY

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on non-transitory computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

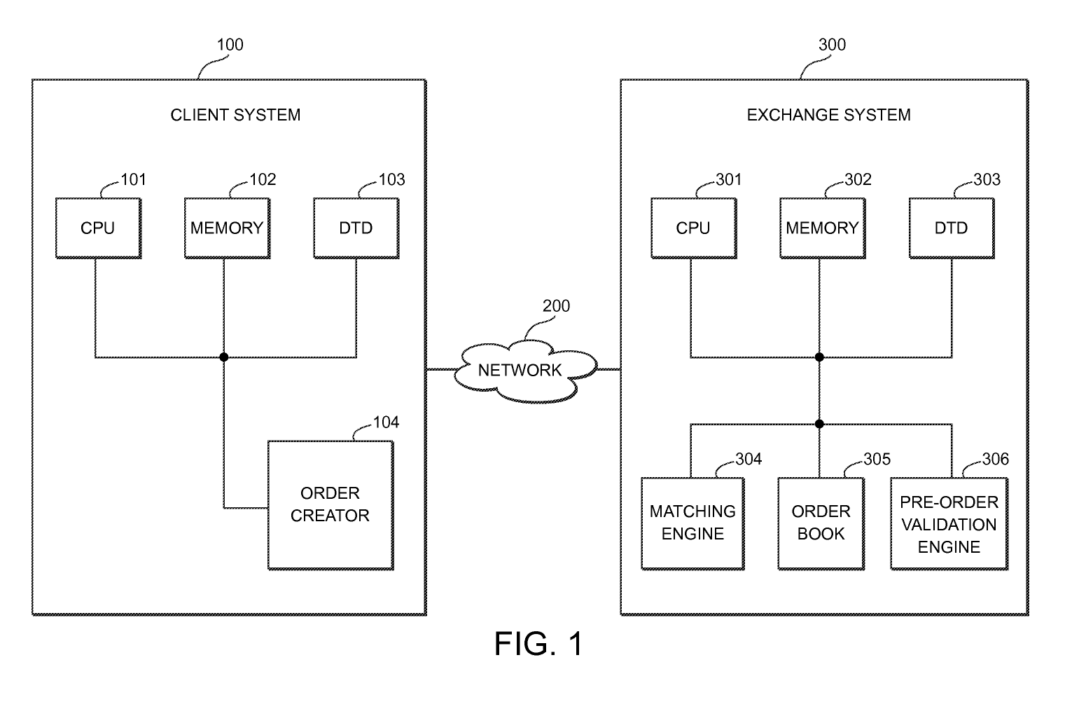

FIG. 1 shows a function block diagram of an example embodiment of a computer-implemented exchange system 300 coupled via a network 200 to a client system 100 configured to create and place orders with the exchange 300. The client system 100 can be implemented with and/or used via a personal computer, a PDA device, a cell phone, a server computer, or any other system/device for conducting the electronic exchange described herein. The client system 100 can be any individual and/or business entity conducting electronic trading with the exchange. The exchange system 300 communicates with a plurality of client systems 100 to match orders.

The client system 100 includes a central processing unit (CPU) 101, a memory 102, and a data transmission device 103. The data transmission device (DTD) 103 can be, for example, a network interface device that can connect the client system 100 to the network 200. The connection can be wired, optical, or wireless and can connect over a Wi-Fi network, the Internet, or a cellular data service, for example. The data transmission device 103 can also be an input/output device that allows the broker system 100 to place the data on a computer-readable storage medium. The data transmission device 103 is capable of sending and receiving data (i.e., a transceiver). The client system 100 can be used for conducting exchange with the exchange system 300. The client system 100 can take an order from a user for a derivative instrument, for example, send it to the exchange system 300, and the exchange system 300 can attempt to match the order.

The exchange system 300 includes a CPU 301, a memory 302, and a data transmission device 303. In an example embodiment, the exchange system 300 may include multiple processors and/or memories and may be designed for fail-safe redundancy. The data transmission device (DTD) 303 can be, for example, a network interface device that can connect the exchange 300 to the network 200, and is capable of sending and receiving data (i.e. a transceiver).

The exchange system 300 also has a matching engine 304, implemented using one or more processors, for matching orders, an order book memory 305 for storing orders, and a computer-implemented pre-order validation engine 306. The order book 305 can exist in the memory 302 of the exchange system 300.

As discussed above, the exchange system 300 can receive an order placed from the client system 100 via, for example, the network 200. Upon receiving an order, the matching engine 304 attempts to match an order with a corresponding order in the order book 305. Prior to matching the order, the pre-order validation engine 306 performs preorder validation using one or more methods described herein. In an example embodiment, if the order does not successfully match, the exchange 300 can store the order in the order book 305. The exchange system 300 can partially match orders in the order book 305.

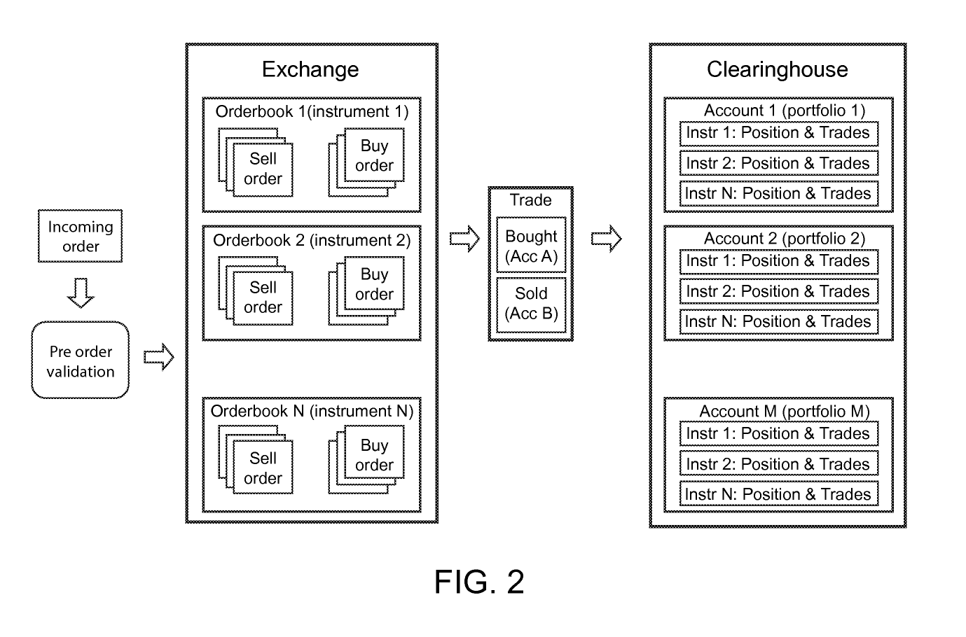

FIG. 2 shows an example block diagram of an exchange interacting with a clearinghouse. An incoming order typically includes various attributes, such as an indication whether to buy/sell an instrument, a limit price/market price on the order, a quantity, and/or an indication of an account, can undergo pre-order validation. The pre-order validation can use information about positions, as discussed further below, from the clearinghouse shown in FIG. 2, and information about orders from the exchange, for each account. It should be appreciated that the pre-order validation system can be implemented in the exchange itself. For example, the pre-order validation system can be a part of a gateway in the exchange for pre-validating orders before the orders are cleared for matching. It should be appreciated that the pre-order validation engine may also prevent orders from being transmitted/passed to the matching engine (i.e., the order is not cleared for processing by the pre-validation engine) when the order does not pass a particular margin requirement check (e.g., in the gateway of the electronic exchange). Thus, the pre-order validation engine can be used to clear or reject orders when they satisfy (or do not satisfy) certain margin requirement checks.

If an order is accepted after pre-order validation, a matching engine attempts to match the incoming order with one or more orders in orderbooks 1-N. A matched order results in a trade, but an unmatched order is simply placed in the order book. If the order matches, the trades are added to the respective account, and the “positions” are updated based on the matched order. At the clearinghouse, the matched order can be added to a portfolio for a given account where each portfolio includes one or more financial instruments comprising positions and trades. The clearinghouse can, for example, have several counterparties, and each counterparty will have one or more accounts. In each account, all trades (for example in different derivative products) are accumulated. This accumulation of trades is also referred to as a portfolio. The account can be akin to a bank account, but in the present technology is sued for bookkeeping of trades instead of money.

A position can be a number of long and short contracts in the instrument. The clearinghouse can also handle expirations, option exercises, and perform margin calculations. Handling upon expiration is processing related to and dependent on the financial product upon expiration (i.e. on the expiration date as established for each financial product). Option exercise relates both to handling upon expiration as well as the case where the option holder requests early exercise (if permitted). In the example shown in FIG. 2, the orders will be handled by the exchange, and the portfolios can be handled by the clearinghouse. The pre-order validation is thus advantageous because it can prevent orders from being matched where an account may not have enough pledged collateral to cover the order should it be matched, which helps protect the clearinghouse from potentially losing money from the transaction.

As explained above, one drawback to the SPAN® system is that only the portfolio associated with an account is evaluated and there is no efficient way for determining a margin requirement for the portfolio that also considers live, unmatched orders in an order book. In non-limiting, example implementations, when an incoming order is received at an exchange, the existing portfolio for that account plus all orders in the orderbook for that account can be evaluated. The evaluation can take into account several SPAN® parameters.

One parameter in particular in the SPAN® calculation is the scanning risk. The system is capable of evaluating scenario points when an incoming order is received. In each scenario point, the profit/loss for all existing positions will be included in the calculation and the profit/loss for each order will be calculated. If there is a loss at the scenario point, the order will be included in the calculation. That is, the worst case in that scenario point is that the order is executed and added to the portfolio. It should be appreciated that an order is an instruction to buy/sell that may or may not be executed. If executed (either wholly or partially), it will result in one trade (or multiple trades if partially executed more than once). The trades can update positions for an account and that instrument. A position is the number of long and short contracts respectively (accumulated). All positions for an account (i.e., for all instruments) represent a portfolio. Thus, a portfolio will only have trades and not orders. A sample illustration of various scenario points is provided below:

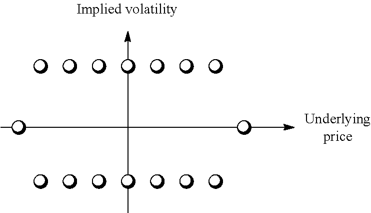

It should be appreciated that a determined profit/loss for a position or an order can be extended with the market value as well as the option premium for orders (not positions) related to the option series. These values can also affect the final margin requirement, and thus it is necessary to also take these values into account when selecting orders to be included in the worst case. The evaluation can be calculated by determining orders with a loss plus a paid premium value minus a received premium and minus a market value. In this case, if there is a loss, the order is included and the market value is also included in the same way for positions because it also affects the final margin requirement.

The loss at the worst case resulting scenario point represents the worst case margin requirement for the portfolio plus the worst case collection of the orders being executed. For this worst case calculation of the scanning risk, the number of calculations is proportional to the number of orders instead of the number of calculations being proportional to an exponentially high number of possible portfolios. This allows an exchange to perform pre-order validation in real-time and automatically performs validation on incoming orders instead of having to wait for the orders to be already executed by the exchange. As explained above, the worst case calculation for the scanning risk can be used to determine if the pledged collateral for an account/order is higher than the worst case calculated risk.

In another non-limiting, example implementation, an upper bound approximation on the intermonth spread charge can be calculated and used as the margin requirement or added to the margin requirement. The effect on an intermonth charge of an incoming order is dependent on the existing configuration of orders and tiers already associated with the portfolio. The tiers can be configured by the clearinghouse. Each tier will contain one or more expiration months, which translates to one or more future/forward series as well a number of option series (depending on what products are handled). So each order is to buy or sell an instrument, and that order will thus have a relationship to one particular tier. Or the other way around, for each tier, there are zero or more orders related to it. Typically the tiers are handled separately for each underlying (different underlyings can have derivative series expiring at the same time).

Traditionally, it is difficult to exactly evaluate the marginal intermonth spread charge of a single order without trying all permutations of orders being matched (or not being matched). However, an upper bound approximation of the intermonth spread charge can be determined. The approximated upper bound of the intermonth spread charge can be calculated by first reducing the tier structure of a combined commodity to a single tier containing all orders. This tier is then assigned a tier spread charge corresponding to the largest preconfigured tier spread charge. The upper bound approximation reaches its maximum value when all orders under consideration are included in the portfolio, as the single tier intermonth spread charge grows with the number of spreads formed. The maximum intermonth spread charge is determined by assuming that all orders are matched and put into the portfolio.

An illustration showing how the tier structure is collapsed into one level is provided below:

| Tier | Positions | | |
|---|---|---|---|
| 1 | long₁ | short₁ | |
| 2 | long₂ | short₂ | |
| . . . | . . . | . . . | → |
| N−1 | long_{N-1} | short_{N-1} | |
| N | long_{N} | short_{N} | |

| Tier | Positions | |
|---|---|---|
| 1 | longₜₒₜ | shortₜₒₜ |

The preconfigured intermonth spread charges can also be collapsed into one level, as illustrated below:

Spread Charges

| Tier | 1 | 2 | . . . | N − 1 | N | |
|---|---|---|---|---|---|---|
| 1 | charge_{1 to 1} | — | — | — | — | |
| 2 | charge_{1 to 2} | charge_{2 to 2} | — | — | — | → |
| . . . | . . . | . . . | . . . | — | — | |
| N − 1 | charge_{1 to N-1} | charge_{2 to N-1} | . . . | charge_{N-1 to N-1} | — | |
| N | charge_{1 to N} | charge_{2 to N} | . . . | charge_{N-1 to N} | charge_{N to N} | |

| Tier | 1 |
|---|---|
| 1 | max(charge_{i to j}) |

The upper bound approximation of the intermonth spread charge can be combined with the worst case scanning risk calculation, discussed above, to modify the worst case margin requirement. As it is an upper bound of the intermonth spread charge, the component cannot add more to the margin requirement than determined above and this solution once again helps make it possible for an exchange to perform pre-order validation in real-time while automatically performing validation on incoming orders instead of having to wait for the orders to execute.

In another non-limiting, example implementation, an upper bound approximation of the delivery month charge can also be calculated. It should be appreciated that a delivery month charge normally only applies for a particular delivery month and any other orders or positions can only transform outrights into spreads. As an example, an underlying might have 8 future instruments (e.g., expiring each quarter for two years to come). Those represent 8 different maturities. For each maturity, there could be several option instruments (call and put of many different strike prices). The future closest to expire as well as all the option instruments for that maturity are said to be for the delivery month. A position (or aggregated deltas for all delivery month instruments in a combined commodity) could have 10 long (positive deltas) and 7 short (negative deltas), with 7 spreads and 3 outrights (on the positive side). As a non-limiting example, a delta can express a derivative instrument's sensitivity to underlying price changes. A future will have the value +1 since its value will increase by 1 USD if the underlying price goes up 1 USD. For a call option it will vary between 0 and +1. A delta value of 0.6 means that the value will increase by 60 cents if the underlying prices goes up 1 USD. For a put option it varies between −1 and zero. The instrument delta will be multiplied with the position, i.e. number of contracts (positive number for long positions and negative number for short positions). The result can be called position delta, or just deltas as used in the text (i.e. the delta can be a number that will be positive or negative (or possibly zero)).

As a further example, for other maturities of the same combined commodity, there can be 5 outrights (also on the positive side) and some spreads. An incoming order for a non-delivery month with 2 negative deltas will execute resulting in having 9 spreads in the delivery month. That is, 2 outrights will have been “transformed” into spreads.

Using the assumption that the outright charges are larger than the spread charges, we can ignore these calculations since this would reduce the margin requirement (thereby not providing an upper bound approximation). In analyzing the portfolio(s) for an account, two portfolios are selected with one containing only orders in the order book with long positions included and one portfolio with only orders with short positions included. The portfolios can be two “scenario” portfolios that both contain all the positions in the actual portfolio. The orders are divided based on whether they would contribute with positive or negative deltas. The portfolio with the largest number of outrights is selected as the worst-case portfolio. Two example cases are provided below.

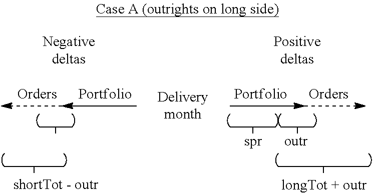

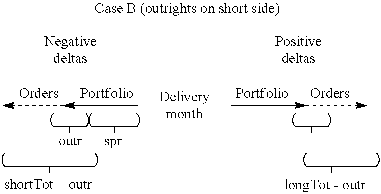

The upper bound approximation of the delivery month charge can be combined with the worst case scanning risk calculation (and the upper bound of the intermonth spread charge approximation), discussed above, to modify the worst case margin requirement. As it is an upper bound of the delivery month charge, the component cannot add more to the margin requirement than determined above and this solution once again helps make it possible for an exchange to perform pre-order validation in real-time while automatically performing validation on incoming orders instead of having to wait for the orders to execute.

Although the above methods can be implemented for any type of orders, the methods are particularly useful for performing preorder validation for derivatives risks. By performing preorder validation with the methods described above on derivatives, a more refined preorder validation scheme is provided that allows for more accurate margin calculations and possibly allowing more incoming orders to be matched.

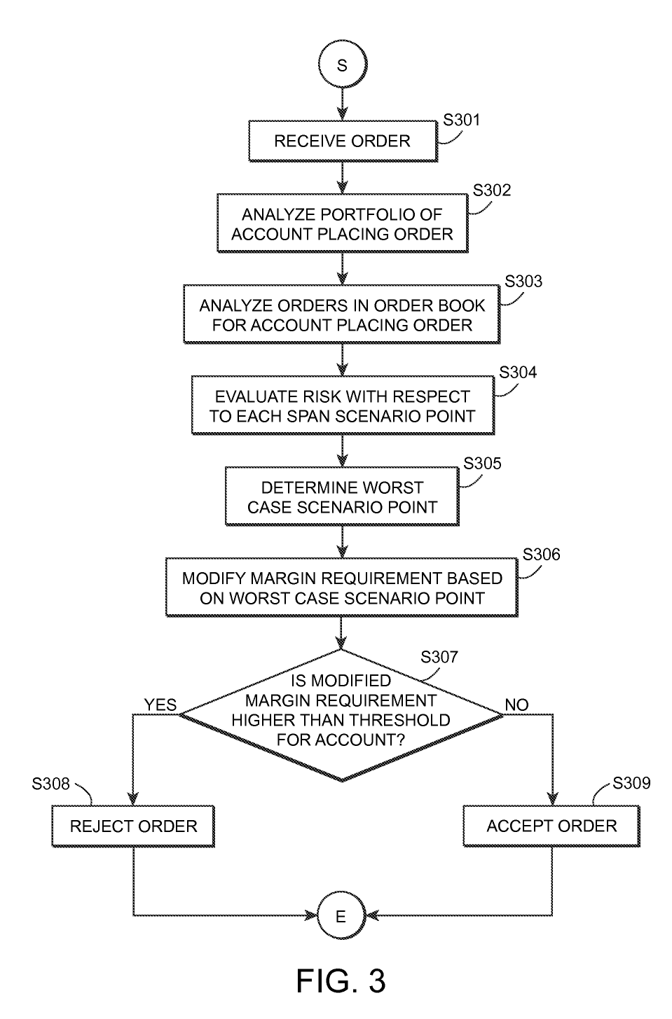

FIG. 3 shows an example application flowchart of a method for calculating a scanning risk during preorder validation by the preorder validation engine 306. The process begins by the exchange system 300 receiving an order (S301) from a client system 100, for example. The portfolio of the account placing the order is then analyzed (S302). In a non-limiting, example implementation the portfolio includes multiple positions, and each position is analyzed for each scenario point when determining a scanning risk (S304).

After analyzing the portfolio, orders in the order book for the particular account placing the order are analyzed (S303). Similar to the analysis for the positions in the portfolio, the order book, in an example implementation, will contain multiple orders for an account in addition to the incoming order. For each scenario point in the scanning risk calculation, each order in the order book is analyzed for each scenario point (S304).

Upon evaluating the risk with respect to each scenario point (S304), the process proceeds to determine the worst case scenario point in the scanning risk evaluation (S305). The scenario point with the worst case margin is then used to modify the margin requirement (S306). This can be accomplished by simply setting the margin requirement to the worst case scenario point or by adding the value found for the worst case scenario point to the total margin requirement. For example, the margin requirement may also be modified based on other calculations for various SPAN® parameters (e.g., intermonth spread charge, delivery month charge).

The modified margin requirement (i.e., the margin requirement taking into account the calculated scanning risk) is then compared to the threshold value for an account to allow an order to execute (S307). In an example implementation, the threshold value correlates to the pledged collateral required to cover the highest resulting margin requirement for a worst case execution of the order. If the modified margin requirement is higher than the pledged collateral, the system may then reject the order (S308) and likewise if the modified margin requirement is lower than the pledged collateral, the system may accept/execute the order (S309).

A non-limiting, example pseudo-code representation of the example method shown in FIG. 3 is as follows:

```
Portfolio consisting of positions P1, P2, ... Pn
Orders O1, O2, ... Om are residing in the orderbook
Order O is incoming
Worst = 0
Loop: Scenario points
          Acc = 0
          Loop: Positions in portfolio
                P&L = − Theoretical price change for
                Pi − market_value
                Acc = Acc + P&L
          Endloop positions
          Loop: Orders in the orderbook as well as incoming order
                P&L = −Theoretical price change for Oi +
                premium_paid
                    − premium_received − market_value
                If loss (i.e. P&L > 0)
                    Acc = Acc + P&L
          Endloop orders
If Acc worse than Worst (i.e. Acc > Worst)
          Worst = Acc
Endloop scenario points
```

By calculating the scanning risk in this manner, the required computation resources is significantly more reasonable even when the number of orders in the orderbook for a particular account is growing. This also makes it possible for accurate real-time preorder validation of incoming orders that employ traditional SPAN® methods while also taking into account existing, unmatched orders for a particular account.

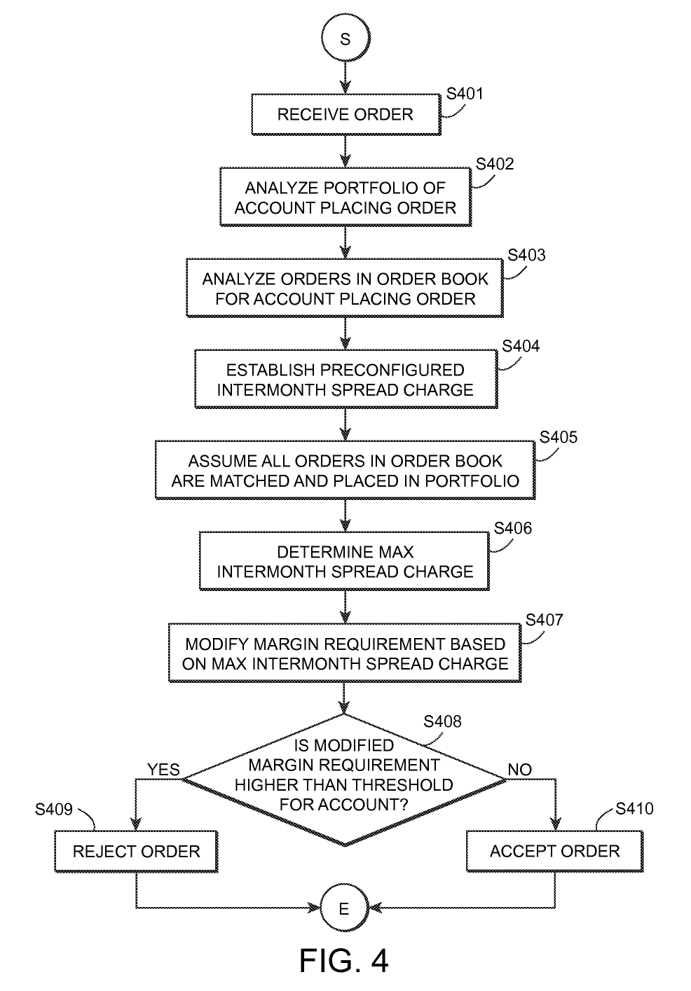

FIG. 4 shows an example application flowchart of a method for calculating an approximate upper bound on an intermonth spread charge during preorder validation by the pre-order validation engine 306. The process begins when the exchange 300 receives an order (S401). Upon receiving the order, the portfolio for the account placing the order is analyzed (S402) as well as the orders in the order book for the particular account (S403).

A preconfigured intermonth tier spread charge is then established (S404) and the overall tier spread charge is set as the max of the preset tier of spread charges. The process can then assume that all orders in the order book are matched and placed in the portfolio (S405) where the process will then determine an approximated upper bound for the intermonth spread charge (S406). In determining the approximate upper bound, the process can loop through all positions in the portfolio plus all orders (orders in the order book plus the incoming order). A number of spreads will be determined based on the total number of long positions determined in the analysis and the total number of short positions determined in the analysis. The spread can then be multiplied by the max tier spread charge to determine the approximated upper bound on the intermonth spread charge.

It should be appreciated that each instrument can have an associated delta which can range from −1 to +1 (for options it is theoretically calculated based on e.g., strike price, underlying price, and volatility). A position delta is (long−short)*instrument delta. For an order, (buy quantity−sell quantity)*instrument delta can be used. For example, a put option with a delta of −0.5 and a short position of 5 will result in a position delta of 2.5 (positive). For a combined commodity (or for a tier within a combined commodity), the positive deltas and negative deltas can be summarized from different instruments.

Upon determining the approximated upper bound on the intermonth spread charge, the margin requirement can be modified based on the upper bound approximation (S407). Similar to modifying the margin requirement based on the calculated worst case scenario point, the margin requirement can add the calculated upper bound value on the intermonth spread charge.

The modified margin requirement (i.e., the margin requirement taking into account the calculated upper bound on the intermonth spread charge) can then be compared to the threshold value for an account to allow an order to execute (S408). In an example implementation, the threshold value will correlate to the pledged collateral required to cover the highest resulting margin requirement for a worst case execution of the order. If the modified margin requirement is higher than the pledged collateral, the system may then reject the order (S409) and likewise if the modified margin requirement is lower than the pledged collateral, the system may accept/execute the order (S410).

A non-limiting, example pseudo-code representation of the example method shown in FIG. 4 is as follows:

```
Portfolio consisting of positions P1, P2, ... Pn
Orders O1, O2, ... Om are residing in the orderbook
Order O is incoming
Tier spread charge = max of preset tier spread charges
longTot = 0
shortTot = 0
          Loop: Positions in portfolio + orderbook + incoming order
                PosD = Position delta of the position or order
                if(PosD > 0)
                      longTot = longTot + PosD
                else
                      shortTot = shortTot − PosD
                      ## shortTot will be a positive number of
negative deltas
          Endlooop
spreads = min (longTot, shortTot)
intermonth spread charge = tier spread charge*spreads
```

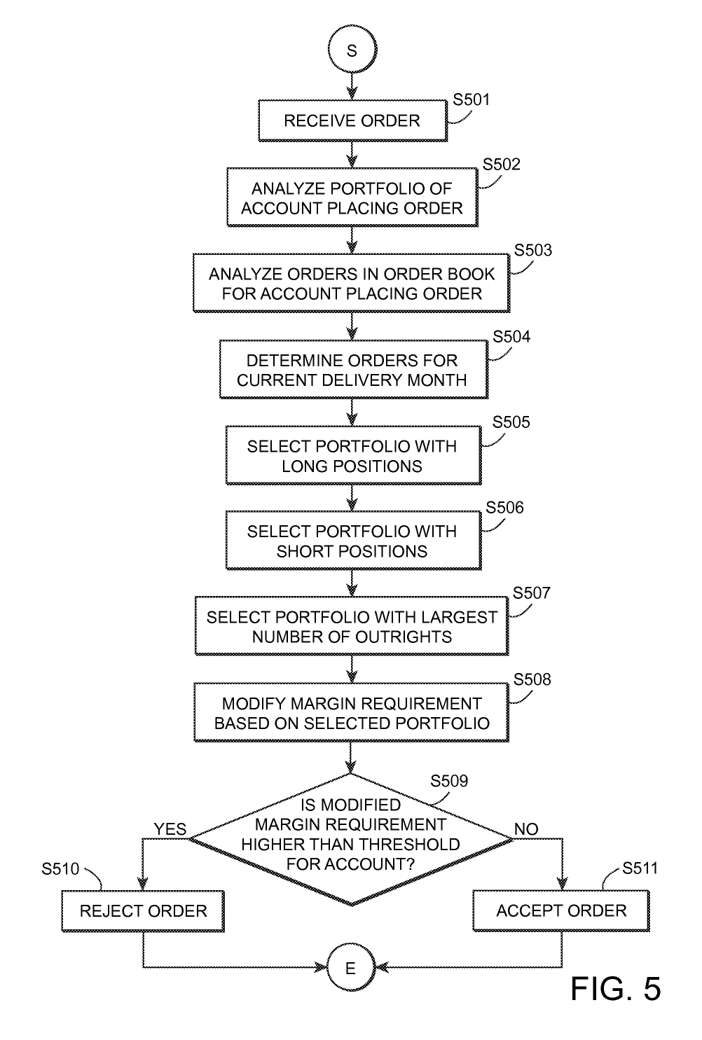

FIG. 5 shows an example application flowchart of a method for calculating an approximate upper bound on a delivery month charge during preorder validation by the pre-order validation engine 306. The process begins when the exchange 300 receives an order (S501). Upon receiving the order, the portfolio for the account placing the order is analyzed (S502) as well as the orders in the order book for the particular account (S503).

The orders executing for a determined delivery month can next be determined (S504). In an example implementation, these orders could be for instruments that are near expiration. For example, the delivery month could be the nearest non-expired month within a term of an instrument contract (e.g., an order expiring July 31 with a July delivery month).

Upon determining the orders for a specified delivery month, two portfolios are selected. The first portfolio relates to one with only orders in the order book with long positions included (S505) and the second portfolio relates to one with only orders with short positions included (S506). The portfolio with the largest number of outrights is selected (S507) as the worst case portfolio with which to approximate the upper bound calculation of the delivery month charge. It should be appreciated that spreads represent the number of positive deltas that are balanced by an equal number of negative deltas, and outrights can be deltas on the bid side that cannot be balanced by any remaining deltas on the other side (after the spreads have formed).

The margin requirement can then be modified based on the approximate upper bound calculation of the delivery month charge (S508). Similar to the scanning risk and intermonth spread charge, the delivery month charge can be added to the total margin requirement.

The modified margin requirement (i.e., the margin requirement taking into account the calculated upper bound on the delivery month charge) can then be compared to the threshold value for an account to allow an order to execute (S509). In an example implementation, the threshold value will correlate to the pledged collateral required to cover the highest resulting margin requirement for a worst case execution of the order. If the modified margin requirement is higher than the pledged collateral, the system may then reject the order (S510) and likewise if the modified margin requirement is lower than the pledged collateral, the system may accept/execute the order (S511).

A non-limiting, example pseudo-code representation of the example method shown in FIG. 5 is as follows:

```
Portfolio consisting of positions P1, P2, ... Pn
Orders O1, O2, ... Om are residing in the orderbook
Order O is incoming
o_charge = preconfigured charge for outright positions in delivery month
s_charge = preconfigured charge for spread positions in delivery month
spr = number of spread deltas in the portfolio for the delivery month
outr = number of outright deltas in the portfolio for the delivery month
side = 1 if outrights are on the long side, otherwise −1
longTot = 0
shortTot = 0
          Loop: Orders in the orderbook as well as the incoming
          order O
                if order is not for delivery month
                      continue with the next iteration of the loop
                delta = Delta of order Oi
                if(delta > 0)
                      longTot = longTot + delta
                else
                      shortTot = shortTot − delta
                      ## shortTot will be a positive number of
negative deltas
          Endloop
          if (side > 0)
                new_outr = max (longTot+outr, shortTot−outr)
          else
                new_outr = max (longTot − outr, shortTot+outr)
delivery_month_charge = spr*s_charge + new_outr*o_charge
```

It should be appreciated that the processes described above in FIGS. 3-5 can be performed as separate pre-order validations or as one whole pre-order validation. For example, when determining the margin requirement with respect to the scanning risk as shown in FIG. 3, if the order is rejected no further analysis will be carried out where if the order is accepted, the process can then determine the margin requirement with respect to the intermonth spread charge as shown in FIG. 4. Likewise, if an order is accepted after the analysis with respect to the intermonth spread charge, further analysis can be conducted with respect to the delivery month charge as shown in FIG. 5. That is, it is only when the sum of all margin components have been determined to be less than the threshold value that the order will be accepted where acceptance means that the order is sent to the matching engine where other validations can take place.

It should also be appreciated that SPAN® calculations presently take place for accounts (i.e., portfolios) and are carried out by a clearinghouse. The pre-order validation described above can take place before the order reaches the matching engine (and subsequently before it is matched and added to a portfolio in the clearinghouse). The SPAN® calculations can be done on behalf of the clearinghouse, which allows the clearinghouse to avoid the risk that a counterparty (i.e., investor) rapidly sends in orders that if/when are traded result in a portfolio for which it cannot pledge the necessary collateral in the traditional manner (i.e., a situation where the buffer capital in the form of pledged collateral will not be sufficient for the clearinghouse in case the counterparty goes into default at this time).

While the technology has been described in connection with non-limiting, example embodiments, it is to be understood that the claims are not to be limited to the disclosed embodiments, but on the contrary, cover various modifications and equivalent arrangements.

1. A method for pre-validating orders submitted to an exchange system, prior to the orders being accepted by the exchange system for matching, the method implemented in a pre-order validation apparatus having at least one processor, the method comprising:
receiving an electronic data message including an order for pre-order validation, the order comprising information associated with an account;
performing a risk analysis for portfolios associated with the account to determine if, based on the risk analysis, the received order will be cleared so that the exchange can attempt to match the received order;
performing the risk analysis for unmatched orders, previously accepted for matching at the exchange, associated with the account and the received order to determine if the received order will be cleared so that the exchange can attempt to match the received order;
calculating, by the at least one processor, a margin requirement value for the account based on the risk analysis performed for the portfolios and the orders;
determining, by the at least one processor, if the margin requirement value for the account is higher than a threshold value for the account; and
clearing the order for matching when the margin requirement value for the account is equal to or lower than the threshold value for the account.

2. The method of claim 1, wherein components of the margin requirement value calculations are determined based on at least one of a scanning risk, an intermonth spread charge, or a delivery month charge.

3. The method of claim 2, further comprising:
establishing one or more scenario points for the account, each scenario point based on an underlying price and a volatility;
determining, for each of the one or more scenario points, a profit or a loss value;
determining a worst case scenario point representing a highest loss and setting the profit or loss value in the worst case scenario point as the scanning risk; and
modifying the margin requirement value based on the highest loss in the scanning risk.

4. The method of claim 3, further comprising:
identifying, by the at least one processor, each order that contributes with a loss in each scenario point, and wherein determining the profit or loss value for each of the one or more scenario points comprises:
calculating, by the at least one processor, a profit or loss value wherein the calculation is based on a profit or loss value of the portfolios and a loss value associated with the identified orders in each scenario point.

5. The method of claim 3, further comprising:
setting the intermonth spread charge to a predetermined value;
reducing a tier structure having a plurality of tiers to a single tier containing all orders;
assigning a tier spread charge corresponding to a largest preconfigured tier spread charge;
determining an upper bound value of the intermonth spread charge based on the tier spread charge and an assumption that all orders in the order book have been matched; and
modifying the margin requirement value based on the upper bound value.

6. The method of claim 3, further comprising:
determining a delivery month based on a current calendar month;
determining one or more orders in the orderbook for an account that could match for the delivery month;
calculating one or more portfolios based on the one or more orders in the orderbook that could match for the delivery month;
selecting a first portfolio having a highest number of long positions;
selecting a second portfolio having a highest number of short positions;
determining whether the first portfolio or the second portfolio has a highest number of outright positions;
selecting either the first portfolio or the second portfolio when the portfolio is determined to have the highest number of outright positions;
determining an upper bound value of the delivery month charge based on the selected first or second portfolio; and
modifying the margin requirement value based on the upper bound value of the delivery month charge.

7. The method of claim 3, wherein the margin requirement value may be modified by adding together one or more of the scanning risk, the intermonth spread charge, and the delivery month charge.

8. A non-transitory computer-readable storage medium having computer readable code embodied therein and capable of being stored in a memory as computer program instructions, which when executed by a computer having one or more processors, performs functionality comprising:
receiving an electronic data message including an order for pre-order validation, the order comprising information associated with an account;
performing a risk analysis for portfolios associated with the account to determine if, based on the risk analysis, the received order will be cleared so that the exchange can attempt to match the received order;
performing the risk analysis for unmatched orders, previously accepted for matching at the exchange, associated with the account and the received order to determine if the received order will be cleared so that the exchange can attempt to match the received order;
calculating, by the at least one processor, a margin requirement value for the account based on the risk analysis performed for the portfolios and the orders;
determining, by the at least one processor, if the margin requirement value for the account is higher than a threshold value for the account; and
clearing the order for matching when the margin requirement value for the account is equal to or lower than the threshold value for the account.

9. A pre-order validation apparatus, comprising:
a memory configured to store one or more orders for pre-order validation processing; and
at least one processor, coupled to the memory, and configured to execute pre-validation of orders submitted to an exchange system, prior to the orders being accepted by the exchange system for matching, the at least one processor configured to perform functionality comprising:
receiving an electronic data message including an order for pre-order validation, the order comprising information associated with an account,
performing a risk analysis for portfolios associated with the account to determine if, based on the risk analysis, the received order will be cleared so that the exchange can attempt to match the received order,
performing the risk analysis for unmatched orders, previously accepted for matching at the exchange, associated with the account and the received order to determine if the received order will be cleared so that the exchange can attempt to match the received order,
calculating, by the at least one processor, a margin requirement value for the account based on the risk analysis performed for the portfolios and the orders,
determining, by the at least one processor, if the margin requirement value for the account is higher than a threshold value for the account, and
clearing the order for matching when the margin requirement value for the account is equal to or lower than the threshold value for the account.

10. The pre-order validation apparatus of claim 9, wherein components of the margin requirement value calculations are determined based on at least one of a scanning risk, an intermonth spread charge, or a delivery month charge.

11. The pre-order validation apparatus of claim 10, wherein the at least one processor is further configured to perform functionality comprising:
establishing one or more scenario points for the account, each scenario point based on an underlying price and a volatility;
determining, for each of the one or more scenario points, a profit or a loss value;
determining a worst case scenario point representing a highest loss and setting the profit or loss value in the worst case scenario point as the scanning risk; and
modifying the margin requirement value based on the highest loss in the scanning risk.

12. The pre-order validation apparatus of claim 11, wherein the at least one processor is further configured to perform functionality comprising:
identifying, by the at least one processor, each order that contributes with a loss in each scenario point, and wherein determining the profit or loss value for each of the one or more scenario points comprises:
calculating, by the at least one processor, a profit or loss value wherein the calculation is based on a profit or loss value of the portfolios and a loss value associated with the identified orders in each scenario point.

13. The pre-order validation apparatus of claim 11, wherein the at least one processor is further configured to perform functionality comprising:
setting the intermonth spread charge to a predetermined value;
reducing a tier structure having a plurality of tiers to a single tier containing all orders;
assigning a tier spread charge corresponding to a largest preconfigured tier spread charge;
determining an upper bound value of the intermonth spread charge based on the tier spread charge and an assumption that all orders in the order book have been matched; and
modifying the margin requirement based on the upper bound value.

14. The pre-order validation apparatus of claim 11, wherein the at least one processor is further configured to perform functionality comprising:
determining a delivery month based on a current calendar month;
determining one or more orders in the orderbook for an account that could match for the delivery month;
calculating one or more portfolios based on the one or more orders in the orderbook that could match for the delivery month;
selecting a first portfolio having a highest number of long positions;
selecting a second portfolio having a highest number of short positions;
determining whether the first portfolio or the second portfolio has a highest number of outright positions;
selecting either the first portfolio or the second portfolio when the portfolio is determined to have the highest number of outright positions;
determining an upper bound value of the delivery month charge based on the selected first or second portfolio; and
modifying the margin requirement value based on the upper bound value of the delivery month charge.

15. A pre-order validation system, comprising:
an order creating device having:
a memory configured to store one or more orders;
at least one processor coupled to the memory and configured to process the one or more stored orders; and
a data transceiver device configured to conduct transmission of one or more orders; and
a pre-order validation apparatus having:
a memory configured to store one or more orders for pre-order validation processing;
a data transceiver device configured to conduct transmission of the one or more orders transmitted from the order creating device; and
at least one processor, coupled to the memory and the data transceiver, and configured to execute pre-validation of orders submitted to an exchange system, prior to the orders being accepted by an exchange system for matching, the at least one processor configured to perform functionality comprising:
receiving an electronic data message including an order for pre-order validation, the order comprising information associated with an account,
performing a risk analysis for portfolios associated with the account to determine if, based on the risk analysis, the received order will be cleared so that the exchange can attempt to match the received order,
performing the risk analysis for unmatched orders, previously accepted for matching at the exchange, associated with the account and the received order to determine if the received order will be cleared so that the exchange can attempt to match the received order,
calculating, by the at least one processor, a margin requirement value for the account based on the risk analysis performed for the portfolios and the orders,
determining, by the at least one processor, if the margin requirement value for the account is higher than a threshold value for the account, and
clearing the order for matching when the margin requirement value for the account is equal to or lower than the threshold value for the account.

16. The pre-order validation system of claim 15, wherein components of the margin requirement value calculations are determined based on at least one of a scanning risk, an intermonth spread charge, or a delivery month charge.

17. The pre-order validation system of claim 16, wherein the at least one processor in the pre-order validation apparatus is further configured to perform functionality comprising:
establishing one or more scenario points for the account, each scenario point based on an underlying price and a volatility;
determining, for each of the one or more scenario points, a profit or a loss value;
determining a worst case scenario point representing a highest loss and setting the profit or loss value in the worst case scenario point as the scanning risk; and
modifying the margin requirement value based on the highest loss in the scanning risk.

18. The pre-order validation system of claim 17, wherein the at least one processor in the pre-order validation apparatus is further configured to perform functionality comprising:
identifying, by the at least one processor, each order that contributes with a loss in each scenario point, and wherein determining the profit or loss value for each of the one or more scenario points comprises:
calculating, by the at least one processor, a profit or loss value wherein the calculation is based on a profit or loss value of the portfolios and a loss value associated with the identified orders in each scenario point.

19. The pre-order validation system of claim 17, wherein the at least one processor in the pre-order validation apparatus is further configured to perform functionality comprising:
setting the intermonth spread charge to a predetermined value;
reducing a tier structure having a plurality of tiers to a single tier containing all orders;
assigning a tier spread charge corresponding to a largest preconfigured tier spread charge;
determining an upper bound value of the intermonth spread charge based on the tier spread charge and an assumption that all orders in the order book have been matched; and
modifying the margin requirement based on the upper bound value.

20. The pre-order validation system of claim 17, wherein the at least one processor in the pre-order validation apparatus is further configured to perform functionality comprising:
determining a delivery month based on a current calendar month;
determining one or more orders in the orderbook for an account that could match for the delivery month;
calculating one or more portfolios based on the one or more orders in the orderbook that could match for the delivery month;
selecting a first portfolio having a highest number of long positions;
selecting a second portfolio having a highest number of short positions;
determining whether the first portfolio or the second portfolio has a highest number of outright positions;
selecting either the first portfolio or the second portfolio when the portfolio is determined to have the highest number of outright positions;
determining an upper bound value of the delivery month charge based on the selected first or second portfolio; and
modifying the margin requirement value based on the upper bound value of the delivery month charge.
